(19) United States
(12) Patent Application Publication
(10) Pub. No.: US 2014/0122465 A1
(43) Pub. Date: May 1, 2014

(54) Ranking Music Search Results

(71) Applicants: Brandon Bilinski, San Francisco, CA (US); Owen Otto, Oakland, CA (US); Ting Tang, Union City, CA (US)

(72) Inventors: Brandon Bilinski, San Francisco, CA (US); Owen Otto, Oakland, CA (US); Ting Tang, Union City, CA (US)

(21) Appl. No.: 13/664,859

(22) Filed: Oct. 31, 2012

(51) Int. Cl. G06F 17/30

(52) U.S. Cl. 707/723; 707/E17.014

(57) ABSTRACT

A system, method and computer-readable medium for ranking music items (songs, artists, albums, etc.) listed in a search result. The system may include a user database storing user-managed music items and a public database storing a universe of music items. A music ranking application configured to receive a search query, identify music items in response to the query, and provide a ranked result list to the user. Different characteristics of the music items are weighted to provide a score for the music item, the score indicating the relevance of the music item when compared to user data and universal data associated with the item. The weighted scores are used to determine the ranking of the music item and can be adjusted based on user feedback, resulting in an adjusted ranking of the music items listed in the search result.

### TECHNICAL FIELD

The present disclosure relates generally to systems, methods, and computer programs for ranking music search results based on both user data and public data associated with a music item.

### BACKGROUND

Individuals typically maintain a personal music library on their home computer, mobile device, and/or remote storage location. Similarly, the Internet and various music distributors maintain vast music libraries. Searching for a particular music item (track, album, artist, playlist, etc.) is typically completed using a query entered by the user. Because a user's music library and a distributor library can contain a huge number of music items, locating a desired track, album, artist, etc. can be challenging.

Typical search tools attempt to return search results based on search terms entered by the user, the goal of which is to provide relevant results based on the query. In general, the search tools accomplish this by matching the terms in the user query to a corpus of pre-stored data about the music item. Music items that contain the user's search terms are identified and are returned to the user.

In an attempt to increase the relevancy and quality of the music results returned to the user, a search tool may attempt to sort the list of hits so that the most relevant and/or highest quality music items are at the top of the list returned to the user. Conventional methods of determining relevance are based on the contents of the music item or data associated with the music item. For example, the contents and associated data are compared to the terms of the user's query and the music items with the highest correlation are returned to the user.

One goal is to return the most desirable set of music items in response to a search query. Thus, it is desirable to improve the ranking algorithm used by search tools and to therefore provide users with better search results.

### SUMMARY

One aspect provides a computer-implemented method for ranking music items listed in a search result. The method may include identifying a personal item characteristic associated with a music item. The method may further include determining a personal weight factor for the personal item characteristic and a personal score of the music item based on the personal item characteristic and the personal weight factor. The method may further include ranking the music item based on the personal item score, receiving a user request for the music item, and providing search results containing the music item to the user sorted according to the ranking of the music item.

Another aspect provides a system for ranking of music items, the system comprising: a user database adapted to store a plurality of music items and associated user item characteristics; a public database adapted to store the plurality of music items and associated public item characteristics; and a processor. The processor may be configured to identify a plurality of user item characteristics associated with a music item and a plurality of public item characteristics associated with the music item. The processor may be further configured to calculate a personal score based on a weighted aggregate of the user item characteristics; calculate a public score based on a weighted aggregate of the public item characteristics; rank the music item based the personal score and the public score; receive a query for the music item; and provide the music item in a search result listing sorted according to the music item rank.

Another aspect provides a non-transitory computer-readable storage medium having computer-readable program instructions stored therein. The computer-readable program instructions may include instructions for identifying a personal item characteristic associated with a music item, determining a personal weight factor for the personal item characteristic, determining a personal score of the music item based on the personal item characteristic and the personal weight factor, and ranking the music item based on the personal item score.

### BRIEF DESCRIPTION OF THE DRAWINGS

FIG. 1 is a block diagram depicting an operating environment of a music ranking system in accordance with certain example embodiments.

FIG. 2 is a block diagram depicting an operating environment of a music ranking system in accordance with certain example embodiments.

FIG. 3 is a flow chart depicting a method for ranking music items in accordance with certain example embodiments.

FIG. 4 is a flow chart depicting a method for ranking music items in accordance with certain example embodiments.

FIG. 5 is an example embodiment of a functional block diagram of a computing device.

### DETAILED DESCRIPTION

The present disclosure relates generally to systems, methods, and computer programs for ranking music search results based on both user data and public data associated with a music item. While the examples provided herein refer to music items, alternate embodiments may involve other types of content such as books or videos. Ranking of search results may take into account information about the user, information about the music item, and universal/public data associated with the music item. The overall system providing ranked search results is described.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive music items or other content from a server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as a city, ZIP code, or state level), so that a particular location of a user cannot be determined. Thus, the user may have control over how information is collected about the user and used by a server.

As used throughout the specification, music item is to be broadly interpreted to include any machine-readable electronic media, work product, instruction, video content, document, computer-implemented instructions, etc. An example music item may include, for example, electronic media such as audio files, video files, image files, web casts, podcasts, etc., or any other form of information that can exist in a computer-based environment. For example, a music item can include an audio file including a song, an album, or any portion of a song or an album. The music item can include various types of data used to identify the music item itself. For example, the music item can also include information identifying the particular song, album, and artist associated with the music item. Example data can include a song title, an album title, artist information, song lyrics, album cover art, release date, a website associated with the artist/album/song, etc. The music item can also include supplemental and/or ancillary information associated with the song, artist, or album. For example, the music item can include a web site, a calendar or calendar entry, a file, a combination of files, one or more files with embedded links to other files, a news group posting, a blog, a blog post, advertisement, or any of the aforementioned information.

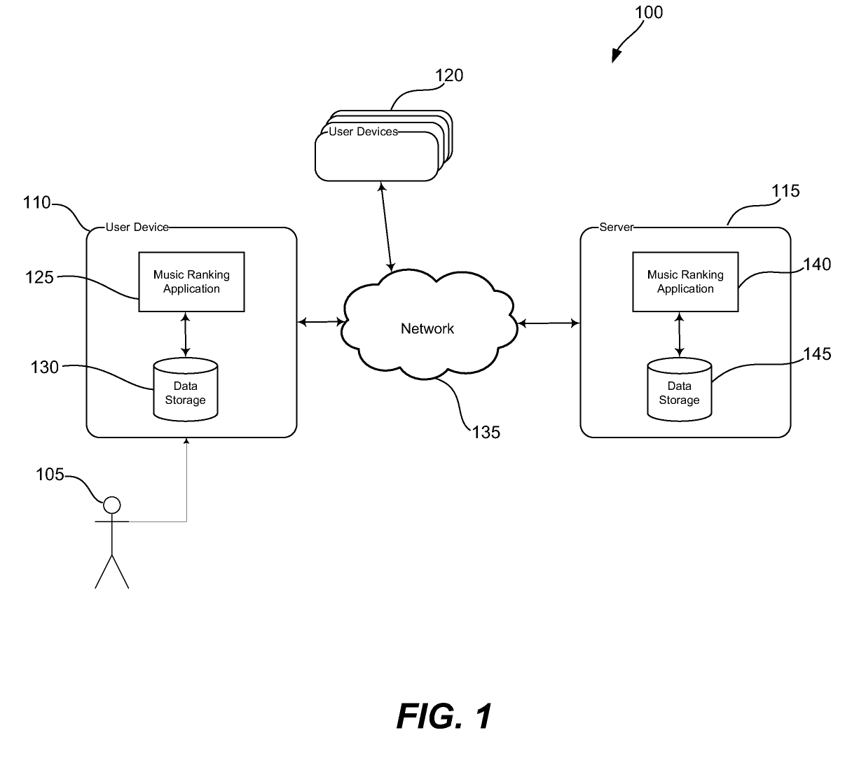

FIG. 1 illustrates the main components of operating environment 100 for a music ranking system in accordance with certain example embodiments. An example music ranking system can be embodied as a stand-alone application program or as a companion program to a web browser having messaging and storage capabilities. While certain embodiments are described in which parts of the music ranking system are implemented in software, it will be appreciated that one or more acts or functions of the music ranking system may be performed by hardware, software, or a combination thereof, and may be embodied in one or more computing systems.

An example operating environment 100 includes a user device 110 associated with a user 105, a server 115, and a plurality of other user devices 120. The user device 110 can be an electronic device capable of storing and playing music items associated with the user 105. The user device 110 may be a personal computer, portable media player or digital audio player (e.g., portable MP3 player), mobile device, (e.g., notebook computer, tablet computer, netbook computer, e-Reader, personal digital assistant (PDA), video game device, GPS locator device, cellular telephone, smartphone, or other mobile device), and may comprise a music ranking application 125 including and/or coupled to a web browser, such as GOOGLE'S CHROME, MICROSOFT'S INTERNET EXPLORER®, or MOZILLA+S FIREFOX®.

In an example embodiment, the user device 110 may include a data storage unit 130 used to store the music items associated with the user 105. The example data storage unit 130 can include one or more tangible computer-readable storage devices. The data storage unit 130 can be stored on the user device 110 or can be logically coupled to the user device 110. For example, the data storage unit 130 can include a hard drive, a microdrive, an on-board flash memory and/or one or more removable memory cards or removable flash memory. The user device 110 can also includes a hard disk drive for reading from and writing to a hard disk (not shown), a magnetic disk drive for reading from or writing to a removable magnetic disk such as a floppy disk, and an optical disk drive for reading from or writing to a removable optical disk such as a CD-ROM, compact disk—read/write (CD/RW), DVD, or other optical media. In an example embodiment, the user device 110 can employ a ROM, a RAM, a hard disk drive, a removable magnetic disk, a removable optical disk, and/or other types of computer-readable media. The drives and their associated computer-readable media can provide non-transitory, non-volatile storage of computer-executable instructions, data structures, program modules, and other data for the user device 110, including, for example, a music ranking application 125. A number of modules can be stored on the ROM, RAM, hard disk drive, magnetic disk, or optical disk, including operating instructions for the music ranking application 125.

The music ranking application 125 includes various routines, sub-routines, programs, objects, components, data structures, etc., which perform particular tasks or implement particular abstract data types. The example music ranking application 125 can facilitate access to music items and data stored in the data storage unit 130. The music ranking application 125 may be used to sort and rank the music items stored in the data storage unit 130. In an example embodiment, the music ranking application 125 may be used to rank and sort music items listed in a search result of a search performed of the data storage unit 130, other user devices 120, and/or the server 115. It is also contemplated that the music ranking application 125 may be used for purchasing music items and/or downloading music items to the user device 110 from the server 115 and/or the other user devices 120. The music ranking application 125 may also be used to share music items between the user device 110, the server 115, and the user devices 120.

The music ranking application 125 can provide a user interface, via the user device 110, for receiving user input and displaying data to the user 105. Using the user device 110 and the music ranking application 125, the user 105 can input, capture, view, download, upload, edit, and otherwise create, access, and manipulate music items and associated data. The user 105 can enter commands and information to the music ranking application 125 at the user interface using input devices integral to, or coupled to, the user device 110. For example, the user 105 can input commands and data using input devices, such as, a touch screen, keyboard, pointing device, camera, and microphone. The pointing device can include a mouse, a trackball, or a stylus/electronic pen that can be used in conjunction with the user device 110.

The user device 110 can include a display integral or coupled to the user device 110. The display can provide images and information associated with the music ranking application 125 to the user 105. In an alternate embodiment, the computer system 110 can include a monitor connected to the computer system 110. In addition to the display, the computer system 110 can include other peripheral output devices, such as speakers and a printer.

The example operating environment 100 also includes other user devices 120. The other user devices 120 include one or more similar system components as the user device 110. For example, the other user devices 120 may include a music ranking application (not shown) and a data storage unit (not shown), each performing the same or similar function as the corresponding components of the user device 110. In an example embodiment, the other user devices 120 are associated with the user 105, however, it is contemplated that the other user devices 120 may be associated with individuals or parties other than the user 105.

The example operating environment also includes a server 115. Using the server 115, music item distribution and data storage is provided. The server 115 may be operated by a music provider, an artist, a record label, or any other party or individual responsible for the marketing and distribution of music items. The server 115 can include one or more computer systems. An example computer system can include a server-side music ranking application 140, a data storage unit 145, and a system bus that couples system components, including the data storage unit 145 to the server music ranking application 140. In an example embodiment, the server 115 may include or be coupled to a web browser.

While the user 105 can interact with the user-side music ranking application 125 via the user device 110 to search, add, modify, or remove music items stored on the data storage unit 130, the user 105 can similarly interact with the server 115 using the server music ranking application 140 and/or the music ranking application 125 to access music items stored at the data storage unit 145. In an example embodiment, the server music ranking application 140 can include various routines, sub-routines, programs, objects, components, data structures, etc., which perform particular tasks or implement particular abstract data types. The example server music ranking application 140 can facilitate the collection and processing of data necessary for ranking music items stored in the data storage unit 145 and completing queries of the music items stored in the data storage unit 145. In an example embodiment the server music ranking application 140 can send and receive data between the user 105, the user device 110, the other user devices 120, and the server 115 via the communication network 120 or a web browser.

The example server 115 includes a data storage unit 145 accessible by the server music ranking application 140. The example data storage unit 145 can include one or more tangible computer-readable storage devices. The server 115 can also include a hard disk drive for reading from and writing to a hard disk (not shown), a magnetic disk drive for reading from or writing to a removable magnetic disk such as a floppy disk, and an optical disk drive for reading from or writing to a removable optical disk such as a CD-ROM, compact disk—read/write (CD/RW), DVD, or other optical media. Although an example computer system can employ a ROM, a RAM, a hard disk drive, a removable magnetic disk, and a removable optical disk, other types of computer-readable media can also be used in the example server 115. The drives and their associated computer-readable media can provide non-transitory, non-volatile storage of computer-executable instructions, data structures, program modules, and other data for the server 115. A number of modules can be stored on the ROM, RAM, hard disk drive, magnetic disk, or optical disk, including operating instructions for the server music ranking application 140.

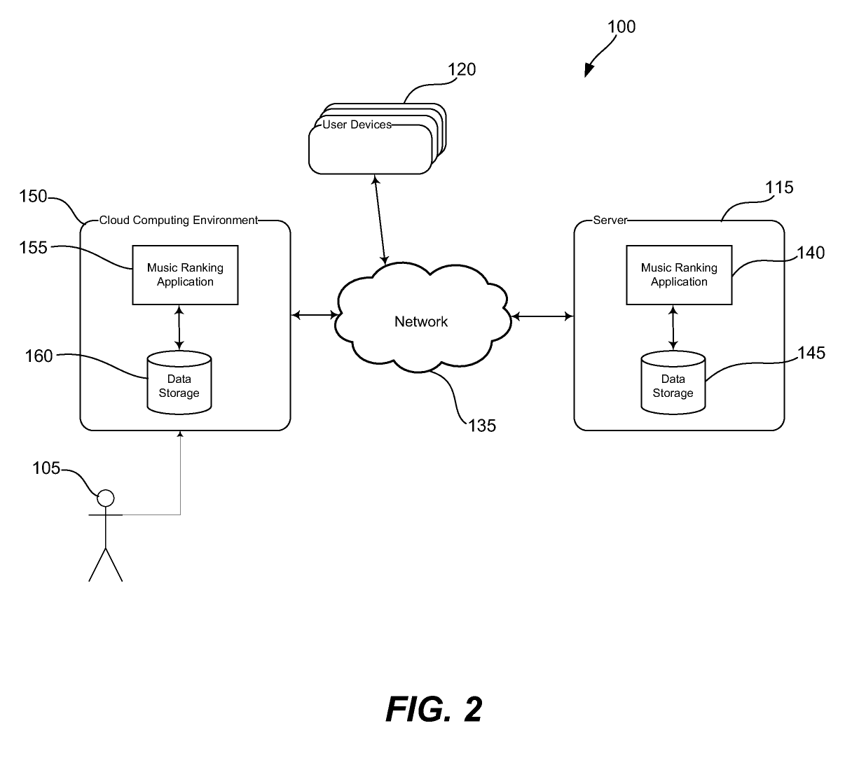

As illustrated in FIG. 2, an example operating environment 100 can include a cloud computing environment 150. In certain example embodiments, multiple cloud computing environments 150 may be employed. The cloud computing environment 150 may include one or more similar system components as the user device 110. For example, the cloud computing environment 150 may include a music ranking application 155 and a data storage unit 160, each performing the same or similar function as the corresponding components of the user device 110. For example, the example music ranking application 155 may facilitate access to music items and data stored in the data storage unit 160. Similarly, the music ranking application 155 may be used to sort and rank the music items stored in the data storage unit 160. Likewise, the example music ranking application 155 may be used to sort and rank music items listed in a search result of a search performed of the data storage unit 160, the other user devices 120, and/or the server 115. In such an embodiment, the user 105 can access the music ranking application 155 and the music data stored at the data storage unit 160 using another device, such as a desktop computer or mobile computing device (not shown) connected to the network 135.

The example operating environment 100 includes a network 135 providing a wired or wireless communication system or device by which network devices (including devices including user device 110, server 115, user devices 120, and cloud computing environment 150) can exchange data. For example, via the network 135 and using the music ranking application 125/155, the user 105 can complete a search for music items stored on the user device 110, cloud computing environment 150, server 115, and/or the other user devices 120. In a further example, the user 105 can preview, listen to, view, download, upload, or otherwise access music items via the distributed network 135. In an example embodiment, the network 135 can include a telecommunications network, a local area network (LAN), a wide area network (WAN), an intranet, an Internet, or any combination thereof. It will be appreciated that the network connections disclosed are example and other means of establishing a communications link between the user device 110, server 115, user devices 120, and cloud computing environment 150 can be used.

The network devices (user device 110, server 114, other user devices 130, and cloud computing environment 150) are configured to operate in a wired and/or wireless communication environment including communication network 135. An example user device 110 and/or cloud computing environment 150 can communicate with the server 115 and the other user devices 120 using various forms of wireless technology. For example, the user device 110/cloud computing environment 150 can communicate using various transmission methods via the communication network 135, such as, a local area network (LAN), a wide area network (WAN), an intranet, an Internet, or other suitable wireless technology. In an example embodiment, the user device 110 is further configured to communicate using various radio transmissions via the communication network 135, such as, a near field communication (NFC) link or a BLUETOOTH link.

The components of the example operating environment 100 have been described with reference to the example systems illustrated in FIGS. 1 and 2. The example embodiments can include one or more computer programs that embody the functions described herein and illustrated in the appended flow charts. However, it should be apparent that there could be many different ways of implementing aspects of the example embodiments in computer programming, and these aspects should not be construed as limited to one set of computer instructions. Further, a skilled programmer would be able to write such computer programs to implement example embodiments based on the flow charts and associated description in the application text. Therefore, disclosure of a particular set of program code instructions is not considered necessary for an adequate understanding of how to make and use the example embodiments. Further, those skilled in the art will appreciate that one or more acts described may be performed by hardware, software, or a combination thereof, as may be embodied in one or more computing systems.

It is contemplated that the user device 110, server 115, other user devices 120, and the cloud computing environment 150 may also include one or more similar computer system components. Those having ordinary skill in the art having the benefit of the present disclosure will appreciate that the user device 110, server 115, other user devices 120, and the cloud computing environment 150 can have any of several other suitable computer system configurations.

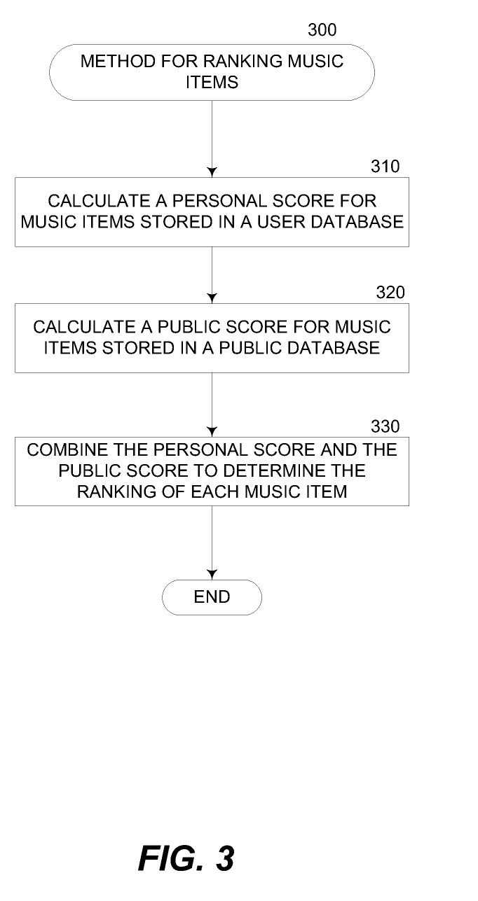

FIG. 3 is a flow chart depicting a method 300 for ranking music items in accordance with certain example embodiments. It is contemplated that any one of the music ranking application 125, 140, and/or 155 can perform the described method of ranking music items, however, example music ranking application 125 will be used in describing method 300.

In an example embodiment, personal scores of the music items stored in the data storage unit 130 are calculated. (Step 310). The personal score for a music item is determined based on the combination of user-specific (personal) music item characteristics and their corresponding weight factors.

In an example embodiment, a music item characteristic refers to user-specific data associated with the particular music item. User-specific data, or personal item characteristics, can include, for example, the user's 105 play count of the music item, the user's 105 last play date of the music item, the bitrate of the music item as selected by the user 105 during download/creation, the date the music item was added to (or removed from) a collection and/or playlist resident in the data storage unit 130 and managed by the user 105, information on how frequently and with whom the user 105 has shared the particular music item, and the user's 105 rating of the music item. In an exemplarily embodiment, each music item included in the data storage unit 130 will have a plurality of different user-specific, or personal, music item characteristics. In an example embodiment, each music item included in the data storage unit 130 have at least one similar item characteristic. In an alternate embodiment, each music item included in the data storage unit 130 have different item characteristics.

When determining the personal score for a music item, a weight factor is applied to each of the user-specific item characteristics for a particular music item. In an example embodiment, the weight factors applied to similar item characteristics are the same for each of the music items stored in the data storage unit 130. For example, the weight factors applied to the “play count” characteristic of each of the music items in the storage unit 130 is the same, qualitatively and/or quantitatively. In an alternate embodiment, the weight factors applied to similar item characteristics vary between music items. For example, the weight factor applied to the “play count” characteristic may vary between music items, album, playlists, genres, etc.

In another example embodiment, historical user data is used to determine a weight factor for each user-specific item characteristic associated with a music item. For example, the weighting for a user's item characteristics may begin as the same weighting factor for each item characteristic. However, periodically, the weighting factors can be modified based on historical user data. For example, if a user has a greater tendency to select music items that were recently added, the weighting factor associated with the date a music item was added to the user's personal collection can be assigned a greater weight.

Once the weight factors have been applied to each of the music item characteristics, an aggregate of all the weighted item characteristics for a music item is computed to determine the user-specific score for the music item. In an example embodiment, user-specific scores for every music item in the storage unit 130 are calculated.

Once the personal scores for the music items have been determined, public scores for the music items are calculated. (Step 320). A public score for the music item is determined based on the combination of a public (universal) music item characteristic and a corresponding weight factor. The user device 110 can be used to determine both the personal and public score for the music item. In another embodiment, the server 115 is used to determine both the personal and public score for the music item. In another example embodiment, the user device 110 is used to determine the personal score and the public score is calculated by the other user devices 120 and/or the server 115 and provided to the user device 110.

In an example embodiment, the public music item characteristic refers to public data associated with the music item. Public data, referred to as public/universal item characteristics, is data representative of non-user/universal data associated with the music item. For example, a public music item characteristic includes a universal play count of the music item. The universal play count can include the number of times the music item has been accessed at the universal music item collection on the storage unit 145 and played in whole or in part. The universal play count can also include the number of times an album associated with the music item has been accessed at the universal music item collection on the storage unit 145 and played. The public item characteristic can include a universal purchase count of the music item representative of the number of times the music item has been purchased by different users from the server 115 or directly from other users at the other user devices 120. The public item characteristic can also include a universal collection count representative how many users include that same music item in their personal music library. The public item characteristic can also include a universal search count representative of the number of times users have searched for the music item or for data ancillary to the music item (album, artist information, etc.). It is contemplated that the universal search count can include the number of times the music item as been searched on the internet or on various media sharing websites (e.g., YOUTUBE®). In an example embodiment, the public item characteristic can also include a count of any mention or tagging of the music item on a social media site. For example, an example “social media count” public item characteristic can include the number of times the music item has been tagged, shared, or liked on a social medial site.

In an example embodiment, each music item included in the data storage unit 145 has a plurality of different public music item characteristics. In an example embodiment, each music item included in the data storage unit 145 can have at least one similar public item characteristic. In an alternate embodiment, each music item included in the data storage unit 145 has different public item characteristics.

When determining the public score for the music item, a public weight factor is applied to each of the public item characteristics for a particular music item. For example, as an initial default, public weight factors applied to the public item characteristics can be equal so that no public item characteristic has a greater influence than other public item characteristics in determining a public score for a music item. As an alternate example, a user can begin with public weight factors that are calculated based on the average public weight factors applied for other users. In such an example, if users tended to select music items with more recent release dates as compared to music items with older release dates, the public item characteristic associate with a recent release date can be more heavily weighted.

These public weight factors also can be modified over time to reflect a user's preferences. In another embodiment, historical, non-user-specific, data can be used to determine an initial weight factor for each item characteristic associated with a music item. For instance, if a user demonstrates a preference for music items that are not in the user's personal collection, such as those stored in data storage unit 145 and not stored in data storage unit 130, the public item characteristics can be more heavily weighted than the personal item characteristics. In yet another example embodiment, the initial weight factors applied to similar item characteristics are the same. For example, the initial weight factors applied to the “social media count” characteristic of each of the music items in the storage unit 145 is the same, qualitatively and/or quantitatively. In an alternate embodiment, the initial weight factors applied to similar item characteristics can vary for each music item based on the genre of the music item or another item characteristic. For example, the weight factor applied to the “universal search count” characteristic may vary between classical music items and jazz music items.

Once the weight factors have been applied to each of the public music item characteristics, an aggregate of all the public item characteristics for a particular music item is computed to determine the public score for the music item. In an example embodiment, public scores for each music item in the universal music item collection stored at storage unit 145 are calculated. Alternatively, public scores may only be calculated for each music item stored in the personal music item collection stored at storage unit 130.

The personal scores and the public scores are combined to determine the rank of the corresponding music item. (Step 330). Using the combined personal score and public score, each music item is compared/ranked against the next and ordered from highest score to lowest. In an alternate embodiment, one of the personal score or the public score may not be calculated and the music item is ranked only based on the calculated score. For example, the network 135 may not be available to the user 105 and thereby preventing the user device 110 from receiving the public score for particular music items from the server 115. In a further example, the music item may not be available on the user device and or the server 115, preventing the personal score or the public score to be calculated for that item. If the music ranking application 125 does not have the data necessary to calculate or be provided the public score, the resulting ranking will be based only on the personal score. Similarly, if the music ranking application 125 does not have access to the personal score, the resulting ranking will be based only on the public score.

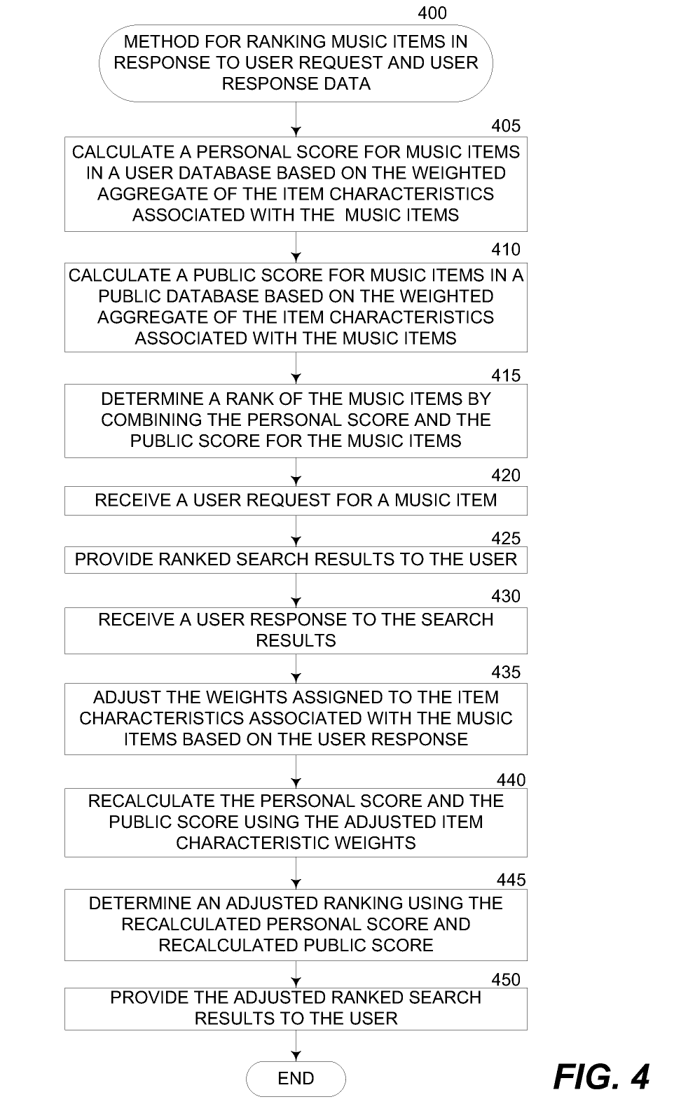

FIG. 4 is a flow chart depicting a method of ranking music items in response to a user request and user response data in accordance with certain example embodiments. Similar to method 300, it is contemplated that any one of the music ranking applications 125, 140, and/or 155 can perform the described method of ranking music items, however, example music ranking application 125 will be used in describing method 400. The method may be initiated based on a user 105 search request of the user's music database stored on the data storage unit 130 or a music database stored on the data storage unit 145 of the server. The user 105 search may be for a particular music item, an album, artist, song title, genre of music, or any other relevant music-related search request by a user 105. Based on historical user 105 data and historical public data, the music items in the data storage unit 130 and/or the data storage unit 145 will have a preliminary rank. Having received the search request, method 400 may be used to rank the results based on the search query and provide the ranked results, from most responsive to least, to the user 105.

In an example embodiment, the music ranking application 125, using historical data stored in the data storage unit 130 and/or the data storage unit 145, determines the personal score for a music item. (Step 405). The personal score is based on the weighted aggregate of each of the user-specific (personal) music item characteristics associated with the music item. The personal score is calculated using initial weight factors determined based on historical user 105 data.

The public score for the music item is then determined by the music ranking application 125 (or the music ranking application 140). (Step 410). Similar to the personal score, the public score is calculated using the public item characteristics and the initial weight factors determined based on historical public data regarding each music item. Using the combined personal score and public score, the music item is initially ranked. (Step 415). In alternate embodiments, only one of the personal score and the public score may be calculated and only one of the personal score and the public score may be used to determine a rank of the music item.

The music ranking application 125 can receive a user's 105 search request for a music item. (Step 420). The user's 105 search query can be entered to search either the user's 105 music library resident on the data storage unit 130, a public music library resident on the data storage unit 145, and/or other user's music libraries resident on the other user devices 120.

Based on the search request, the initially ranked search results are provided to the user 105. (Step 425). In an example embodiment, the relevant music library stored on one of data storage units 130 or 145 or on the other user devices 120 are searched for the requested music item. Using the search query, a search results list of music items is returned which lists music items according to their initial ranking The higher ranking music items appearing higher on search results list.

Having received the initial ranked search results, the user 105 may provide a response/feedback to the music ranking application 125. (Step 430). In an example embodiment, the user's 105 response can include the selection of a particular music for purchase, download, or play, a user's 105 rating of a particular item's relevance in the search result listing, indication that the user scrolled through the search results, the user's selection and playing all of the selected music item, the user playing only a portion of the selected music item, or any other interaction with the results listing that would indicate a user's 105 preference, or lack of preference, for a particular music item.

Based on the feedback received from the user 105, the weights assigned to each of the music item characteristics used in calculating both the personal and public score are adjusted. (Step 435). As described previously, the weights assigned to the personal and public item characteristics can be adjusted based on a variety of criteria including the user's preferences and historical data regarding the user.

Using the adjusted weights, the personal score and public score are recalculated. (Step 440). The recalculated personal score and public score are then used to adjust the ranking of each of the music items. (Step 445). The adjusted ranking of the search results are then provided to the user. (Step 450). In an example embodiment, the adjusted ranking is provided to the user 105 during their initial search query. For example, the search results can adjust dynamically in response to user 105 feedback without requiring the user 105 to enter a new search request. In an alternate embodiment, the adjusted ranking is provided to the user 105 after another search request is entered by the user. For example, the adjusted ranking may be stored and used as a replacement for the initial ranking by the music ranking application 125.

In an example embodiment, the initial and adjusted ranking of the music items can be used to target content to the user 105. In an example embodiment, products or services relevant to music items listed at the top of the ranking may be identified as relevant or of interested to the user 105. For example, based on the ranking, other music items may be suggested to the user 105 including concert/event tickets, merchandise associated with the music item, and related and/or similar music items. In an example embodiment, advertisements for products or services may be targeted to the user based on the ranking

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

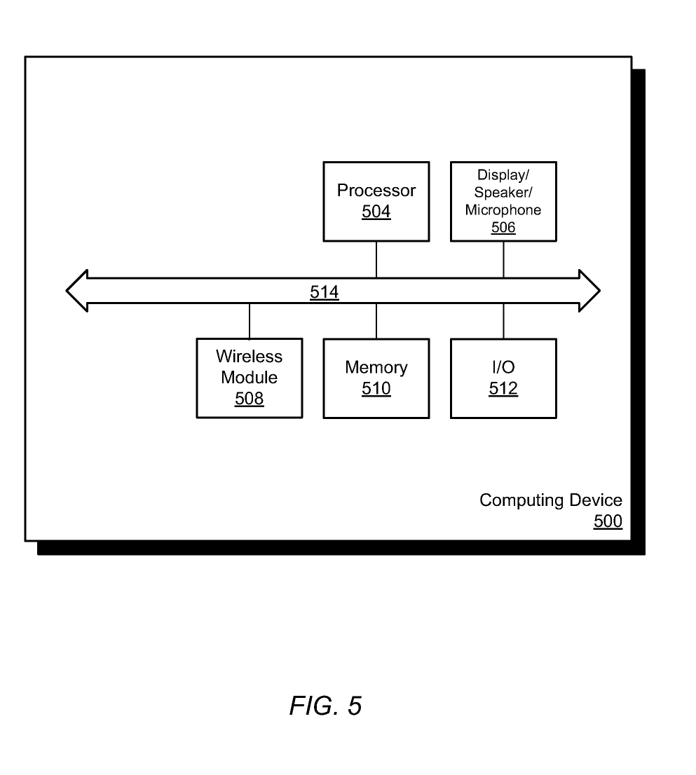

FIG. 5 illustrates an example block diagram of a computing device 500 such as the user computing devices and server computing devices described previously. As illustrated in FIG. 5, the computing device includes processor 504, display/speaker/microphone 506, wireless module 508, memory 510, and I/O 512. In FIG. 5, elements of the computing device 500 are electrically and communicatively interconnected via a bus 514.

The processor 504 may comprise one or more specific or general purpose processors configured to execute instructions stored on the memory 510 that, when executed, control the processor 504 to execute various applications and perform various functions associated with the computing device 500. Additionally or alternatively, the processor 504 may include a programmable gate array and operate, at least in part, based on firmware. As an example, the processor 504 may execute instructions stored on the memory 510 including instructions for an operating system of the computing device 500 and instructions for applications. The applications that may be executed by the computing device 500 include an e-mail application, a photo viewer application, a map viewer application, a web-browser application, a mobile phone application, a music player application, and a music ranking application, among others. The input commands control applications executing on the computing device 500 to perform various tasks or functions associated with the applications.

The display/speaker/microphone 506 is configured to display applications executing on the processor 504 and provide visual and audible feedback to a user of the computing device 500. To that end, the display/speaker/microphone 506 may comprise one or more display devices such as LCD, LED, OLED, and Electronic Ink displays, among others. The display/speaker/microphone 506 may also comprise one or more speakers and one or more microphones.

The wireless communication module 508 is configured to provide wireless communication of data to and from the computing device 500. As a non-limiting group of examples, the wireless communication module 508 may be configured for cellular communications using one or more of GSM, CDMA, TDMA, OFDM and other cellular communications protocols, wireless area network communications using more or more of the family of 802.11x protocols and other wireless area network communications protocols, and Bluetooth communications protocols.

The memory 510 may comprise a Random Access Memory (RAM), Read Only Memory (ROM), or any other tangible storage memory configured to store software programs for execution by the processor 504. As a non-limiting example group, the memory 510 may comprise one or more of dynamic, persistent, and semi-persistent solid state memories, magnetic memories, removable memories, or any other known memories suitable for the application of storing data and software programs for the computing device 500.

The I/O 512 includes inputs and outputs of the computing device 500 such as power connectors, data connectors, and other input and output devices. The I/O 512 may comprise, for example, wired data communication input and output interfaces, power charging interfaces, infra-red interfaces, light and proximity sensors, capacitive sensors, “soft” and “hard” buttons, switches, and other input/output interfaces of the computing device 500. The bus 514 is configured to electrically and communicatively connect the processor 504, the display/speaker/microphone 506, the wireless module 508, the memory 510, and the I/O 512 for transfer of data and instructions between elements of the computing device 500.

The example methods and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent acts corresponding to, the disclosed aspects of the example embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer-implemented method of ranking music items, the method comprising:
identifying, by a processor, a personal item characteristic associated with a music item;
determining, by the processor, a personal weight factor for the personal item characteristic;
determining, by the processor, a personal score of the music item based on the personal item characteristic and the personal weight factor;
determining a ranking, by the processor, of the music item based on the personal item score;
receiving, by the processor, a user request from a user device for the music item; and
providing, by the processor to the user device, a search results list comprising the music item, the search results list sorted according to the ranking

2. The computer-implemented method of claim 1, further comprising:
identifying, by the processor, a public item characteristic associated with the music item;
determining, by the processor, a public weight factor for the public item characteristic; and
determining, by the processor, a public score for the music item based on the public item characteristic and the public weight factor;
wherein, determining the ranking of the music item further includes combining the personal score and the public score.

3. The computer-implemented method of claim 1, wherein the personal item characteristic includes at least one of a user play count, a user play date, a user rating, a bit rate of the music item, an add date associated with a user music library, and a user share data.

4. The computer-implemented method of claim 2, wherein the public item characteristic includes at least one of a universal play count, a universal purchase count, a universal collection count, a universal search count, music item information, and a social media count.

5. The computer-implemented method of claim 1, further comprising:
identifying, by the processor, an other personal item characteristic;
determining, by the processor, an other personal weight factor for the other personal item characteristic;
determining, by the processor, an other personal score for the music item based on the other personal item characteristic and the other personal weight factor;
wherein determining the ranking of the music item further includes combining the personal score and the other personal score.

6. The computer-implemented method of claim 1, further comprising:
determining, by the processor, a personal score of a second music item;
wherein determining the ranking of the music item further includes comparing the personal score of the music item and the personal score of the second music item.

7. The computer-implemented method of claim 2, further comprising:
determining, by the processor, a public score of a second music item;
wherein determining the ranking of the music item further includes comparing the public score of the music item and the public score of the second music item.

8. The computer-implemented method of claim 1, wherein determining the personal score comprises:
assigning a value to the personal item characteristic; and
applying the personal weight factor to the value.

9. The computer-implemented method of claim 2, wherein determining the public score comprises:
assigning a value to the public item characteristic; and
applying the public weight factor to the value.

10. The computer-implemented method of claim 2, further comprising:
receiving a response to the search results list from the user device;
adjusting the personal weight factor based on the response;
adjusting the public weight factor based on the response;
determining an adjusted personal score based on the personal item characteristic and the adjusted personal weight factor;
determining an adjusted public score based on the public item characteristic and the adjusted public weight factor;
wherein, ranking the music item further includes combining the adjusted personal score and the adjusted public score.

11. A system comprising:
a user database adapted to store a plurality of music items and associated user item characteristics;
a public database adapted to store the plurality of music items and associated public item characteristics;
a processor configured to:
identify a music item;
identify from the user database an at least one associated user item characteristic associated with the music item;
identify from the public database an at least one associated public item characteristic associated with the music item;
calculate a personal score based on a weighted aggregate of the at least one associated user item characteristic;
calculate a public score based on a weighted aggregate of the at least one associated public item characteristic;
determine a rank of the music item based the personal score and the public score;
receive a query for the music item; and
provide the music item in a search result listing sorted according to the rank of the music item.

12. The system according to claim 11, wherein the at least one associated user item characteristic includes at least one of a user play count, a user play date, a user rating, a bit rate of the music item, an add date associated with a user music library, and a user share data.

13. The system according to claim 11, wherein the at least one associated public item characteristic includes at least one of a universal play count, a universal purchase count, a universal collection count, a universal search count, music item information, and a social media count.

14. The system according to claim 11, wherein the processor is further configured to:
adjust the personal weight factor and the public weight factor in response to user feedback;
calculate an adjusted personal score and an adjusted public score based on the adjusted personal weight factor and the adjusted public weight factor, respectively; and
adjust the search result listing according to the adjusted personal score and the adjusted public score.

15. A non-transitory computer-readable storage medium having computer-readable program instructions stored therein for execution by a processor, the computer-readable program instructions comprising instructions for:
identifying a personal item characteristic associated with a music item;
determining a personal weight factor for the personal item characteristic;
determining a personal score of the music item based on the personal item characteristic and the personal weight factor; and
determining a ranking of the music item based on the personal item score.

16. The computer program product of claim 15, wherein the computer-readable program instructions further comprise instructions for:
identifying a public item characteristic associated with the music item;
determining a public weight factor for the public item characteristic; and
determining a public score for the music item based on the public item characteristic and the public weight factor;
wherein determining the ranking of the music item further includes combining the personal score and the public score.

17. The computer program product of claim 16, wherein the computer-readable program instructions further comprise instructions for:
receiving a user request from a user device for the music item
providing a search result listing comprising the music item sorted according to the ranking

18. The computer program product of claim 17, wherein the computer-readable program instructions further comprise instructions for:
receiving a response to the search result listing;
adjusting the personal weight factor based on the response;
adjusting the public weight factor based on the response;
determining an adjusted personal score based on the personal item characteristic and the adjusted personal weight factor; and
determining an adjusted public score based on the public item characteristic and the adjusted public weight factor;
wherein, determining the rank of the music item further includes combining the adjusted personal score and the adjusted public score.

19. The computer program product of claim 18, wherein the computer-readable program instructions further comprise instructions for:
providing an adjusted search result listing including the music item list according to the ranking based on the adjusted personal score and the adjusted public score

20. The computer program product of claim 16, wherein the computer-readable program instructions further comprise instructions for:
targeting content to a user based on the ranking of the music item.
